(19) United States
(12) Patent Application Publication
(10) Pub. No.: US 2025/0188994 A1
(43) Pub. Date: Jun. 12, 2025

(54) THREE-ARM AND FOUR-ARM DRIVESHAFT FLANGE AND PRODUCTION METHOD

(71) Applicant: TIRSAN KARDAN SANAYI VE TICARET ANONIM SIRKETI, Yunusemre, Manisa (TR)

(72) Inventors: Turan SOLMAZ, Yunusemre, Manisa (TR); Efe ISIK, Yunusemre, Manisa (TR)

(21) Appl. No.: 18/686,350

(22) PCT Filed: Dec. 5, 2022
(86) PCT No.: PCT/TR2022/051409

§ 371 Date: Feb. 23, 2024

(30) Foreign Application Priority Data
Dec. 10, 2021 (TR) 2021/019614

(51) Int. Cl. F16D 1/076; B60K 17/24; F16D 3/78

(52) U.S. Cl. CPC F16D 1/076; B60K 17/24; F16D 3/78

(57) ABSTRACT

The invention relates to a driveshaft flange used in the driveshaft (M), which provides rotational movement and power transmission between the differential and the gearbox in motor vehicles, and to a production method.

### TECHNICAL FIELD

The invention relates to three-arm and four-arm driveshaft flanges used on the driveshaft providing rotational movement and power transmission between the differential and the gearbox in motor vehicles.

In particular, the invention relates to three-arm and four-arm driveshaft flanges, which are produced from sheet metal by cold forming method and made ready for mounting by fitting together.

### PRIOR ART

In the automotive field, the driveshaft, which provides rotational movement and power transmission between the differential and gearbox in motor vehicles, has a three-arm and four-arm driveshaft flange. The flange in question is fixed by welding on the driveshaft tube on one side and connected to the rubber part with a bolt on the other side. The driveshaft flange, which is welded on the driveshaft tube and mounted to the rubber part with bolts, provides concentricity with the shaft coming out of the gearbox and thus transmits power and motion.

In the present art, three-arm and four-arm driveshaft flanges are produced by hot forming method using forging technology. Driveshaft production with forging technology is carried out as follows; long cylinder rods with cylinder geometry produced by steel manufacturers are cut to the appropriate size. The cut pieces are heated in the oven and made suitable for forging. The heated parts are press forged to obtain the appropriate part shape and the sand blasting process is applied by blasting sand to clean the remaining scale, burrs, etc. on the part after forging. Sandblasted parts are subjected to machining (hole drilling, bolt fitting areas) in order to make them suitable for assembly. Since parts with thin-walled structures cannot be produced due to the mould working logic in forging technology, the driveshaft flange is heavy and a lot of machining is applied due to the geometry coming out of the mould. In addition, since the parts must be heated in order to perform the forging process, high energy costs are incurred due to the heating of the parts at high temperatures and the heat energy in question harms the environment since it is obtained from electricity. For this reason, in the state of the art, a need has arisen for a structure that enables the three arm and four arm driveshaft flange to be manufactured with the optimum design and production method.

As a result, the existence of the above problems and the inadequacy of the existing solutions necessitated a development in the relevant technical field.

### Purpose of the Invention

The present invention relates to a three-arm and four-arm driveshaft flange and manufacturing method, which eliminates the above-mentioned disadvantages and brings new advantages to the relevant technical field.

The main purpose of the invention is to provide three-arm and four-arm driveshaft flanges, which are produced from sheet metal by cold forming method and made ready for mounting by fitting together.

The purpose of the invention is to provide a three-arm and four-arm driveshaft flange which can be produced in two parts as top and bottom parts by cold forming method from sheet metal and which can be joined to each other by fitting and which can achieve the required strength values with its geometric structure.

Another purpose of the invention is to provide a thin-walled and lightweight three-arm and four-arm driveshaft flange, which is manufactured from sheet metal by cold forming method and which does not create useless volume.

Another purpose of the invention is to provide a three-arm and four-arm driveshaft flange which reduces production costs by being manufactured with less raw material in a short time without the need for heat input and by reducing the amount of waste thanks to its production from sheet metal by cold forming method.

Another purpose of the invention is to provide a three-arm and four-arm driveshaft flange, which provides process, cost and weight advantages by reducing the need for machining thanks to its production from sheet metal by cold forming method.

In order to fulfil all the purposes set out above and which may arise from the detailed description, the invention relates to a driveshaft flange used in the driveshaft which provides rotational movement and power transmission between the differential and the gearbox in motor vehicles, and is related with comprising the following;
three-arm driveshaft flange consisting of a triangular three-arm flange produced from sheet metal by cold forming method and a triangular or circular three-arm centring part produced from sheet metal by cold forming method and joined to the three-arm flange by fitting,
four-arm driveshaft flange in quadrangular form produced by cold forming method from sheet metal and four-arm driveshaft flange consisting of four-arm centring piece in circular form produced by cold forming method from sheet metal and joined to the four-arm flange by fitting process.

The invention also relates to a method of manufacturing a driveshaft flange used in the driveshaft which provides rotational movement and power transmission between the differential and the gearbox in motor vehicles, and is related in that it comprises the following process steps;
a) the press-cutting of flat steel material in the form of three-arm flange and three-arm centring part forming three-arm driveshaft flange and/or four-arm flange and four-arm centring part forming four-arm driveshaft flange with cutting mould in the form blanking dies,
b) production of three-arm flange and three-arm centring part forming three-arm driveshaft flange and/or four-arm flange and four-arm centring part forming four-arm driveshaft flange by forming the cut parts in forming press with deep drawing mould,
c) the three-arm flange and three-arm centring part forming the three-arm driveshaft flange and/or the four-arm flange and four-arm centring part forming the four-arm driveshaft flange are joined together by means of an interference fit.

The structural and characteristic features and all advantages of the invention will be more clearly understood by means of the figures given below and the detailed description written with reference to these figures. Therefore, the evaluation should be made by taking these figures and the detailed description into consideration.

### FIGURES TO HELP UNDERSTANDING OF THE INVENTION

FIG. 1a is a top and bottom perspective view of the disassembled three-arm driveshaft flange of the invention driveshaft flange.

FIG. 1b is a top and bottom perspective view of the disassembled three-armed driveshaft flange of the driveshaft flange in the alternative embodiment of the invention

FIG. 1c is a top and bottom perspective view of the disassembled state of the three-arm driveshaft flange of the driveshaft flange in the alternative embodiment of the invention.

FIG. 2a is a top and bottom perspective view of the mounting of the three-arm driveshaft flange of the invention driveshaft flange.

FIG. 2b is a top and bottom perspective view of the mounting of the three-armed driveshaft flange of the driveshaft flange in the alternative embodiment of the invention.

FIG. 2c is a top and bottom perspective view of the mounting of the three-armed driveshaft flange of the driveshaft flange in the alternative embodiment of the invention.

FIG. 3a is a top and bottom perspective view of the disassembled four-arm driveshaft flange of the invention driveshaft flange.

FIG. 3b is a top and bottom perspective view of the disassembled state of the four-arm driveshaft flange of the driveshaft flange in the alternative embodiment of the invention.

FIG. 3c is a top and bottom perspective view of the disassembled state of the four-arm driveshaft flange of the driveshaft flange in the alternative embodiment of the invention.

FIG. 4a is a top and bottom perspective view of the mounting of the four-arm driveshaft flange of the invention driveshaft flange.

FIG. 4b is a top and bottom perspective view of the mounting of the four-arm driveshaft flange of the driveshaft flange in the alternative embodiment of the invention.

FIG. 4c is a top and bottom perspective view of the mounting of the four-arm driveshaft flange of the driveshaft flange in the alternative embodiment of the invention.

FIG. 5 is a view of the three-arm driveshaft flange of the driveshaft flange of the invention mounted on the driveshaft.

FIG. 6 is a view of the four-arm driveshaft flange of the driveshaft flange of the invention mounted on the driveshaft.

### EXPLANATION OF PART REFERENCES

10 Three-arm driveshaft flange
11. Three-arm flange
111. Three-arm flange tube housing
12. Three-arm centring part
121. Three-arm centring part joining extension
122. Three-arm centring part extension
20. Four-arm driveshaft flange
21. Four-arm flange
211. Four-arm flange tube housing
22. Four-arm centring part
221. Four-arm centring part joining extension
222. Four-arm centring part extension
M. Driveshaft tube
K. Rubber part
C. Bolt
S. Nut

### DETAILED DESCRIPTION OF THE INVENTION

In this detailed description, the inventive driveshaft flange and the preferred alternatives of the method of production are described only for a better understanding of the subject matter and without any limiting effect.

The driveshaft flange subject to the invention in its most basic form; a three-arm driveshaft flange (10) consisting of a triangular three-arm flange (11) produced from sheet metal by cold forming method and a triangular three-arm centring part (12) produced from sheet metal by cold forming method and joined to the three-arm flange (11) by fitting, A four-arm driveshaft flange (20) comprising a four-arm flange (21) in quadrangular form produced from sheet metal by cold forming method and a four-arm driveshaft flange (22) consisting of a four-arm centring part (22) produced from sheet metal by cold forming method and joined to the four-arm flange (21) by a fitting process.

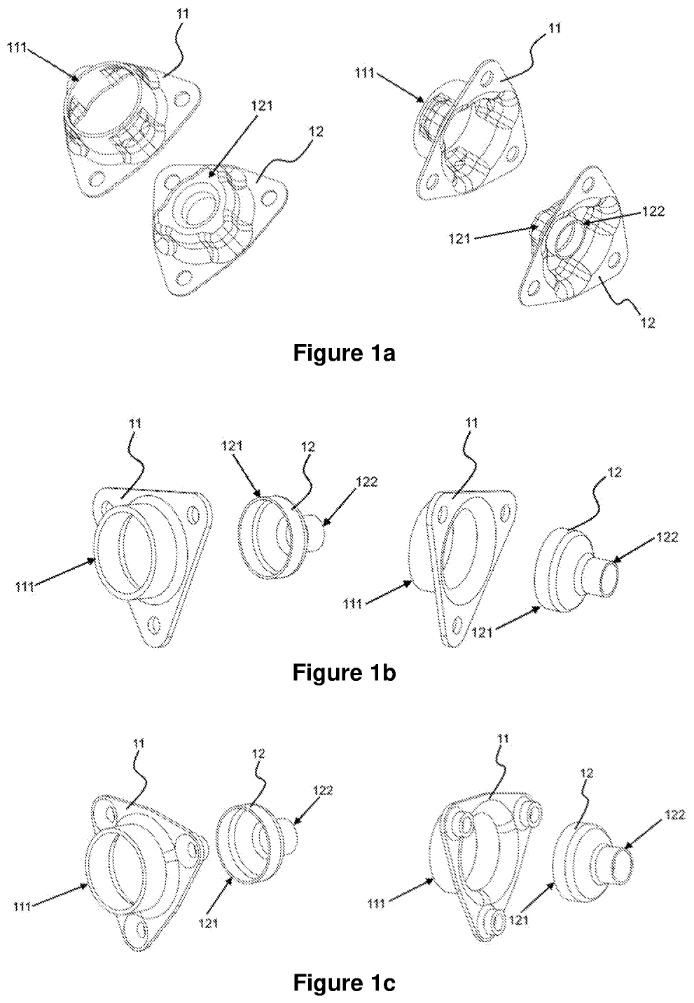

As shown in FIGS. 1a, 1b and 1c, the triangular three-arm flange (11) and the triangular or circular three-arm centring part (12), which form the three-arm driveshaft flange (10), can have a surface form in the form of a recessed-protruding or flat structure as shown in FIGS. 1a, 1b and 1c. Three-arm flange (11) and three-arm centring part (12) are manufactured from sheet metal by cold forming method.

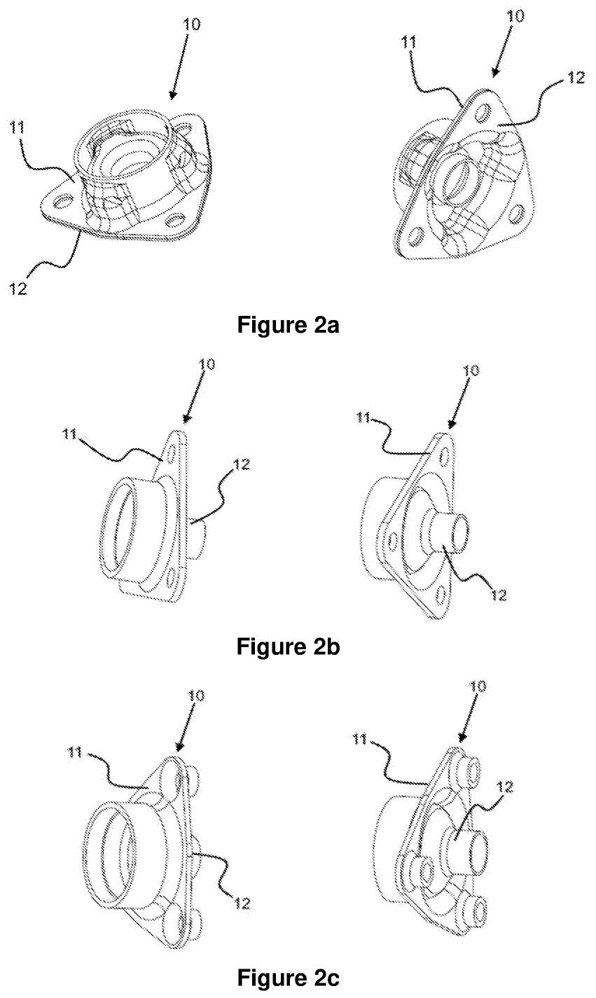

For fixing the three-arm driveshaft flange (10) to the driveshaft tube (M), a three-arm flange tube housing (111) is formed on the surface of the three-arm flange (11). In order to join the three-arm flange (11) and the three-arm centring part (12) to each other by the fitting process, a three-arm centring part joining extension (121) is formed on the top side of the three-arm centring part (12). At the same time, an extension (122) is formed on the bottom side of the three-arm centring part for centring the three-arm driveshaft flange (10). When the three-arm flange (11) and the three-arm centring part (12) are joined together, the three-arm centring part joining extension (121) is inserted into the three-arm flange tube housing (111) from the bottom and the joining is achieved by the insertion process as shown in FIGS. 2a, 2b and 2c.

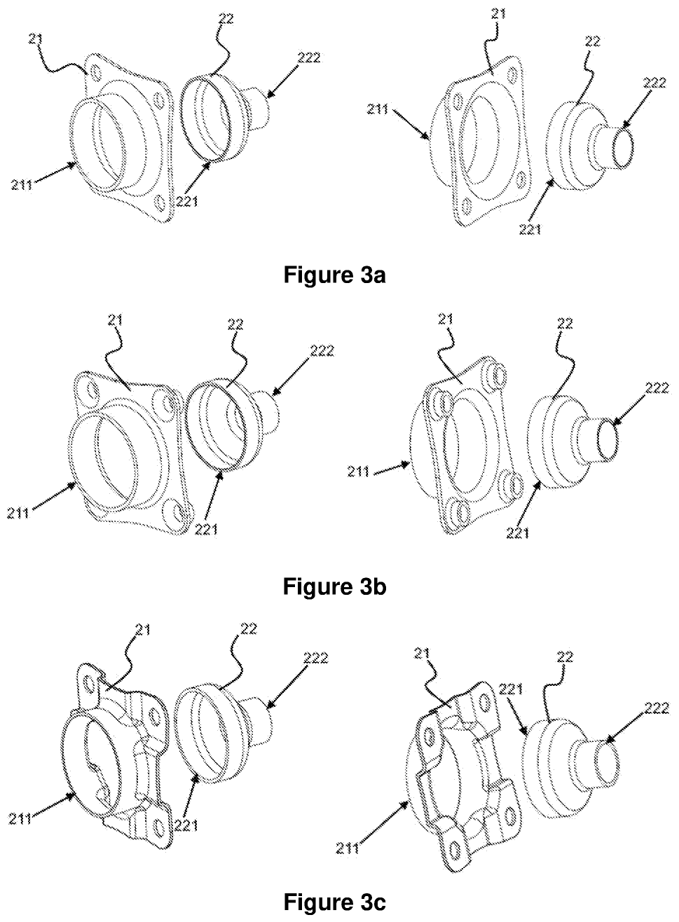

The quadrangular four-arm flange (21) and the circular four-arm centring part (22) forming the four-arm driveshaft flange (20) can have a surface form with a recessed-protruding or flat structure as shown in FIGS. 3a, 3b and 2c. The four-arm flange (21) and four-arm centring part (22) are manufactured from sheet metal by cold forming method.

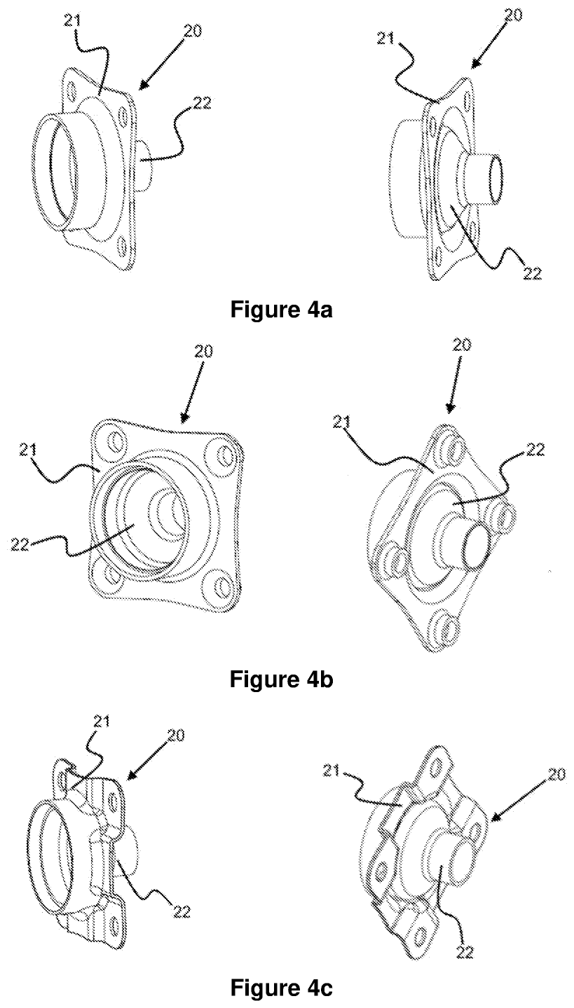

For fixing the four-arm driveshaft flange (20) to the driveshaft tube (M), a four-arm flange tube housing (211) is formed on the surface of the four-arm flange (21). In order to join the four-arm flange (21) and the four-arm centring part (22) to each other by the fitting process, a four-arm centring part joining extension (221) is formed on the top side of the four-arm centring part (22). At the same time, an extension (222) is formed on the bottom side of the four-arm centring part for centring the four-arm driveshaft flange (20). When the four-arm flange (21) and the four-arm centring part (22) are joined together, the four-arm centring part joining extension (221) is fitted into the four-arm flange tube housing (211) from the bottom and the joining is achieved by the fitting process as shown in FIGS. 4a, 4b and 4c.

The process steps of the production method of the driveshaft flange subject to the invention are as follows;
a) Cutting the flat steel material in the press with the cutting mould in the form blanking dies of the three-arm flange (11) and three-arm centring part (12) forming the three-arm driveshaft flange (10) and/or the four-arm flange (21) and four-arm centring part (22) forming the four-arm driveshaft flange (20),
b) Production of three-arm flange (11) and three-arm centring part (12) forming three-arm driveshaft flange (10) and/or four-arm flange (21) and four-arm centring part (22) forming four-arm driveshaft flange (20) by forming the cut parts in the forming press with deep drawing mould,
c) Joining the three-arm flange (11) and three-arm centring part (12) forming the three-arm driveshaft flange (10) and/or the four-arm flange (21) and four-arm centring piece (22) forming the four-arm driveshaft flange (20) by interference fitting.

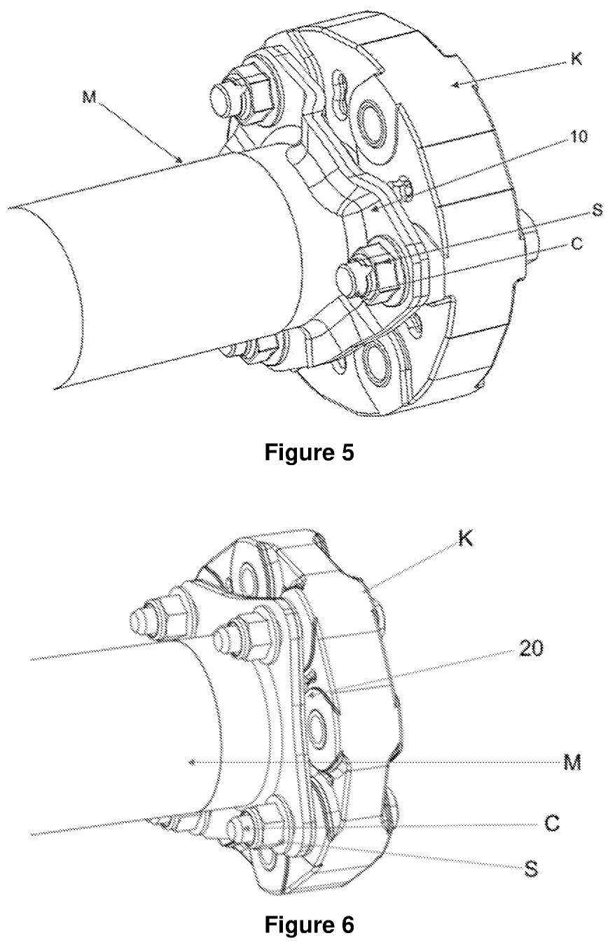

If three-armed driveshaft flange (10) is to be used on the driveshaft (M), the three-armed driveshaft flange (10), which is joined to each other, is welded by connecting the three-armed flange (11) to the driveshaft tube (M) through the three-armed flange tube housing (111) as shown in FIG. 5. The three-arm flange (11), together with the three-arm centring part (12), is fixed to the rubber part (K) by means of bolt (C) and nut(S).

If a four-arm driveshaft flange (20) is to be used on the driveshaft (M), the four-arm driveshaft flange (40), which is joined together, is welded by connecting the four-arm flange (21) to the driveshaft tube (M) by means of the four-arm centring part tube housing (211) as shown in FIG. 4. The four-arm flange (21), together with the four-arm centring part (22), is fixed to the rubber part (K) by means of bolt (C) and nut(S).

1. A driveshaft flange used in a driveshaft, which provides rotational movement and power transmission between a differential and a gearbox in motor vehicles, the driveshaft flange comprising;
a three-arm driveshaft flange comprising a triangular three-arm flange produced from sheet metal by a cold forming method and a triangular or circular three-arm centering part produced from sheet metal by a cold forming method and joined to the three-arm flange by a fitting process; and
a four-arm driveshaft flange comprising a quadrangular four-arm flange produced from sheet metal by a cold forming method and a circular four-arm centering part produced from sheet metal by a cold forming method and joined to the four-arm flange by a fitting process.

2. The driveshaft flange according to claim 1, comprising a three-arm flange tube housing located on the surface of said three-arm flange and enabling the three-arm driveshaft flange to be fixed to the driveshaft tube.

3. The driveshaft flange according to claim 1, by comprising a three-arm centering part joining extension located on the top side of said three-arm centering part, which enables the three-arm flange and the three-arm centering part to be joined to each other by means of a bottom fitting into the three-arm flange tube housing on the surface of the three-arm flange.

4. The driveshaft flange according to claim 1, comprising a three-arm centering part extension located on the underside of said three-arm centering part and enabling the three-arm driveshaft flange to be centered.

5. The driveshaft flange according to claim 1, comprising a four-arm flange tube housing located on the surface of said four-arm flange and enabling the four-arm driveshaft flange to be fixed to the driveshaft tube.

6. The driveshaft flange according to claim 1, comprising a four-arm centering part joining extension on the top side of said four-arm centering part, which allows the four-arm flange and the four-arm centering part to be joined to each other by means of a bottom fitting into the four-arm flange tube housing on the surface of the four-arm flange.

7. The driveshaft flange according to claim 1, comprising a four-arm centering part extension located on the underside of said four-arm centering part and enabling the four-arm driveshaft flange to be centred centered.

8. A production method for a driveshaft flange used in the a driveshaft, which provides rotational movement and power transmission between the a differential and a gearbox in motor vehicles, and comprising the following process steps;
cutting of flat steel material in the form of a three-arm flange and a three-arm centering part forming a three-arm driveshaft flange and/or a four-arm flange and a four-arm centering part forming said four-arm driveshaft flange in the a press with cutting mould in the form of blanking dies,
production of the three-arm flange and the three-arm centering part forming said three-arm driveshaft flange and/or said four-arm flange and the four-arm centering part forming said four-arm driveshaft flange by forming the cut parts in the forming press with deep drawing mould,
joining of the three-arm flange and the three-arm centering part forming the three-arm driveshaft flange and/or the four-arm flange and the four-arm centering part forming the four-arm driveshaft flange by interference fitting.
